(19) United States
(12) Patent Application Publication
(10) Pub. No.: US 2016/0212034 A1
(43) Pub. Date: Jul. 21, 2016

(54) COMMUNICATION MANAGEMENT APPARATUS, COMMUNICATION SYSTEM AND STORAGE MEDIUM

(71) Applicant: HITACHI, LTD., Tokyo (JP)

(72) Inventors: Yusuke Shomura, Tokyo (JP); Katsuyuki Tsunami, Tokyo (JP); Yusuke Obi, Tokyo (JP)

(73) Assignee: HITACHI, LTD., Tokyo (JP)

(21) Appl. No.: 14/994,307

(22) Filed: Jan. 13, 2016

(30) Foreign Application Priority Data
Jan. 21, 2015 (JP) 2015-009153

(51) Int. Cl. H04L 12/26; H04L 29/08; H04L 29/06; H04L 12/841

(52) U.S. Cl. CPC H04L 43/0888; H04L 47/283; H04L 67/02; H04L 69/16

(57) ABSTRACT

To estimate the communication quality of the wireless section in real-time, it is provided a communication management apparatus that manages traffic of a wireless communication system that includes a wireless base station communicating with a terminal, and a gateway apparatus coupled to the wireless base station, the communication management apparatus comprising a processor that executes a program and a storage unit accessed by the processor. The communication management apparatus calculates an estimated value of wireless section throughput between the wireless base station and the terminal using communication quality information obtained from data sent and received by the gateway apparatus.

### CLAIM OF PRIORITY

The present application claims priority from Japanese patent application JP 2015-9153 filed on Jan. 21, 2015, the content of which is hereby incorporated by reference into this application.

### BACKGROUND

The present invention is related to a communication management apparatus that manages the traffic of a wireless communication system.

A wireless communication system such as a cellular communication system includes a transaction management server (TMS) to monitor and control the traffic in the system. The transaction management server evaluates the congestion level of the base station.

The background arts of this technology include JP 2013-179415 A. JP 2013-179415 A describes a wireless communication system configured such that, when the waiting timer, which was activated after the data bearer was established, is up, if an audio bearer has been established, a base station eNB selects a target base station TeNB for a user equipment UE based on an audio congestion level, and notifies the user equipment. If the audio bearer has not been established, the base station eNB selects a target base station TeNB for the user equipment UE based on a data congestion level, and notifies the user equipment UE (See Abstract).

### SUMMARY

Generally, in the wireless communication system, the wireless section throughput is the bottle neck, but it is difficult to directly measure the wireless section throughput in a short cycle. The transaction management server described above monitors the traffic of the base station at a short interval (10 seconds, for example) based on the number of terminals connected to each base station and the data amount transferred by each base station. When the number of terminals connected to each base station and the data amount transferred by each base station exceed predetermined thresholds, respectively, the transaction management server determines that the base station is in a congestion state. However, the load on each base station differs depending on the configuration thereof and usage environment, which makes it difficult to find out an appropriate threshold to judge the congestion level of each base station. To solve this, the congestion level of a base station needs to be determined by obtaining the wireless section throughput of each user in real-time (every several seconds to several tens of seconds) because the wireless section throughput is the indicator that is not affected by the configuration or usage environment of the base station.

If an indicator used to judge the congestion level of the base station differs from a reference indicator used to manage the traffic in the wireless communication system, the respective nodes possibly execute inconsistent controls. For example, in restricting a bandwidth used by a user, if the congestion level of the base station is judged based on the number of connected terminals instead of the user throughput, the bandwidth of the user might be restricted to 500 kbps regardless of the fact that the actual throughput of the user is 1000 kbps. For this reason, a technology that can control the traffic using a single reference indicator for the entire wireless communication system is sought after so that the inconsistent control within the wireless communication system can be prevented.

The representative one of inventions disclosed in this application is outlined as follows. There is provided a communication management apparatus that manages traffic of a wireless communication system that includes a wireless base station communicating with a terminal, and a gateway apparatus coupled to the wireless base station, the communication management apparatus comprising: a processor that executes a program; and a storage unit accessed by the processor. The communication management apparatus calculates an estimated value of wireless section throughput between the wireless base station and the terminal using communication quality information obtained from data sent and received by the gateway apparatus.

According to representative embodiments of the present invention, the communication quality (throughput) of the wireless section can be estimated in real-time. Objects, configurations, and effects other than those described above become apparent from the following description of one embodiment of the present invention.

### BRIEF DESCRIPTION OF THE DRAWINGS

The present invention can be appreciated by the description which follows in conjunction with the following figures, wherein:

FIG. 1 is a diagram illustrating a configuration of a wireless communication system of a first embodiment;

FIG. 2 is a diagram illustrating a configuration of a packet analyzer (DPI) of the first embodiment;

FIG. 3 is a diagram illustrating an example of a configuration of a user information management table of the first embodiment;

FIG. 4 is a diagram illustrating an example of a configuration of a base station information management table of the first embodiment;

FIG. 5 is a diagram illustrating a configuration of an example of a session record management table of the first embodiment;

FIG. 6 is a flowchart of a user presence information update process of the first embodiment;

FIG. 7 is a flowchart of a base station information updating process of the first embodiment;

FIG. 8 is a flowchart of a session record updating process of the first embodiment;

FIG. 9 is a diagram illustrating a communication quality measurement timings of the first embodiment;

FIG. 10 is a diagram illustrating a configuration of a traffic management server of the first embodiment;

FIG. 11 is a diagram illustrating an example of a configuration of a base station communication quality management table of the first embodiment;

FIG. 12 is a diagram illustrating an example of a configuration of a traffic control instruction management table of the first embodiment;

FIG. 13 is a flowchart of a traffic control instruction management process of the first embodiment;

FIG. 14 is a diagram illustrating a configuration of a wireless communication system of a second embodiment;

FIG. 15 is a diagram illustrating a configuration of a parameter server of the second embodiment;

FIG. 16 is a diagram illustrating an example of a configuration of a calculated parameter management table of the second embodiment;

FIG. 17 is a diagram illustrating an example of a configuration of a PM statistics management table of the second embodiment;

FIG. 18 is a diagram illustrating a configuration example of a DPI statistics management table of the second embodiment;

FIG. 19 is a flowchart of a process to generate parameters for estimating a wireless section throughput of the second embodiment;

FIG. 20 is a diagram illustrating a configuration of a wireless communication system of a third embodiment;

FIG. 21 is a diagram illustrating a configuration of a filter server of the third embodiment;

FIG. 22 is a diagram illustrating an example of a configuration of a generated filter management table of the third embodiment; and

FIG. 23 is a flowchart of a filter generation process of the third embodiment.

### DETAILED DESCRIPTIONS OF EMBODIMENTS

Hereinafter, embodiments of the present invention will be described in detail with reference to drawings.

Note that while the following embodiments may be described when necessary in a manner where an embodiment is split into multiple sections or embodiments for the convenience of the description, unless specifically designated as such, they will be understood to complement, modify, relate in detail, and supplement one another.

Also, in the description of the embodiments below, it is understood that the number of each element, or the like (including the number of units, numerical values, quantity, scope, and the like) shall not, unless specified otherwise or clearly necessary in principle, be limited to the specific number used in the description, and they may be greater or smaller than those stated herein.

Further, it goes without saying that in the description of the embodiments below, each constituent element (including elements steps) is not necessarily essential unless specified otherwise or clearly necessary in principle.

In the embodiments herein, LTE which is standardized in 3GPP will be used as an example of a cellular communication system to illustrate a traffic management system configured to acquire the information of an application that caused signaling.

### First Embodiment

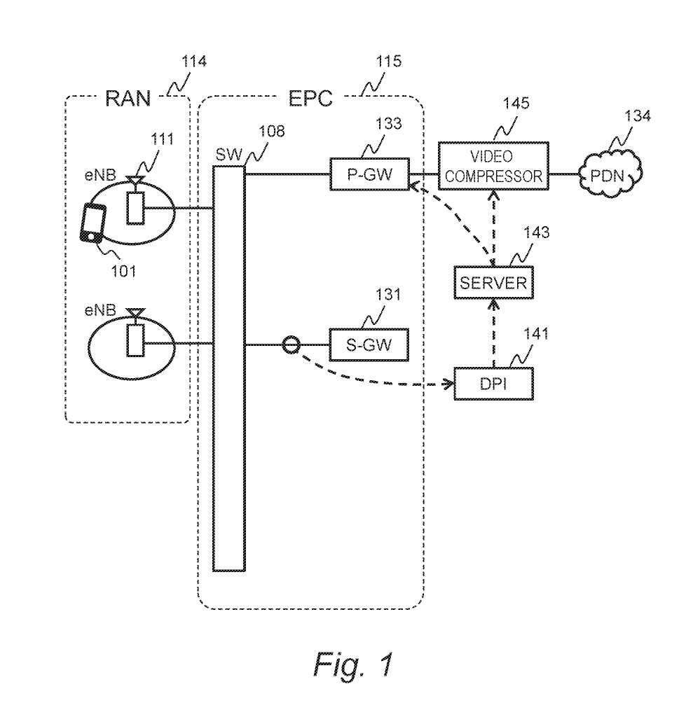

FIG. 1 is a diagram illustrating a configuration of a wireless communication system of a first embodiment.

The wireless communication system of the first embodiment includes an eNodeB 111 as a base station device, an S-GW 131 and a P-GW 133 as gateway apparatuses, a DPI 141 as a packet analyzer, and a traffic management server 143. The wireless communication system may also include a video compressor 145. The eNodeB 111 is connected to a UE 101, which is a user terminal.

The S-GW 131 has the user plane traffic transfer function. The P-GW 133 has an interface with a PDN 134, which is a packet data network providing services to a user. The P-GW 133 may also include the PCEF (policy and charging enforcement function). The PCEF performs the policy control in accordance with predetermined policies. The S-GW 131 and the P-GW 133 are connected to each other, forming a core network (EPC) 115.

The packet analyzer 141 is a device configured to obtain packets transferred through the network as well as the traffic or signaling exchanged between the eNodeB 111 and the S-GW 131. The packet analyzer 141 sends the information of obtained traffic or signaling to the traffic management server 143. Using the information provided by the packet analyzer 141, the traffic management server 143 estimates the state of the traffic (congestion level, for example) of the wireless section between the eNodeB 111 and a terminal 101.

The video compressor 145 controls the amount of video data sent to the UE 101 by changing the compression method or resolution of video sent from a video distribution server (not shown in the figure). In the figure, the video compressor 145 is disposed outside of the EPC 115, but may alternatively be disposed inside of the EPC 115.

A policy control device (PCRF: policy and charging rule function) may be provided between the traffic management server 143 and the P-GW 133. The PCRF defines the policy for the P-GW 133 to control the traffic of the UE 101 based on the wireless section throughput, which was estimated by the traffic management server 143.

In the present embodiment, the DPI 141 is provided for each S-GW 131, and obtains the traffic transferred at reference points S1-U and S11. One DPI 141 may contain a plurality of S-GWs 131, or a plurality of DPIs 141 may contain one S-GW 131. The DPI 141 and the traffic management server 143 may be included in a single calculator.

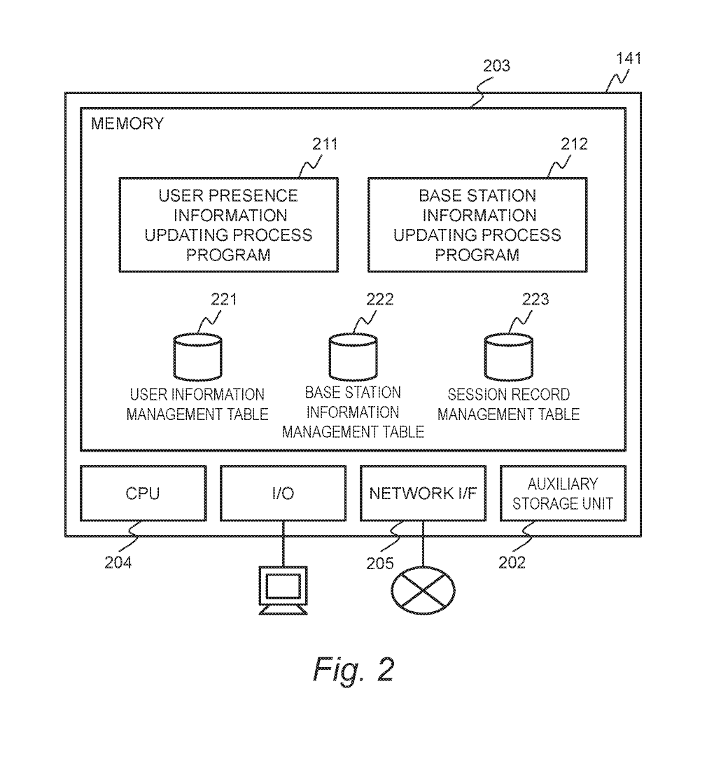

FIG. 2 is a diagram illustrating a configuration of the packet analyzer (DPI) 141 of the first embodiment.

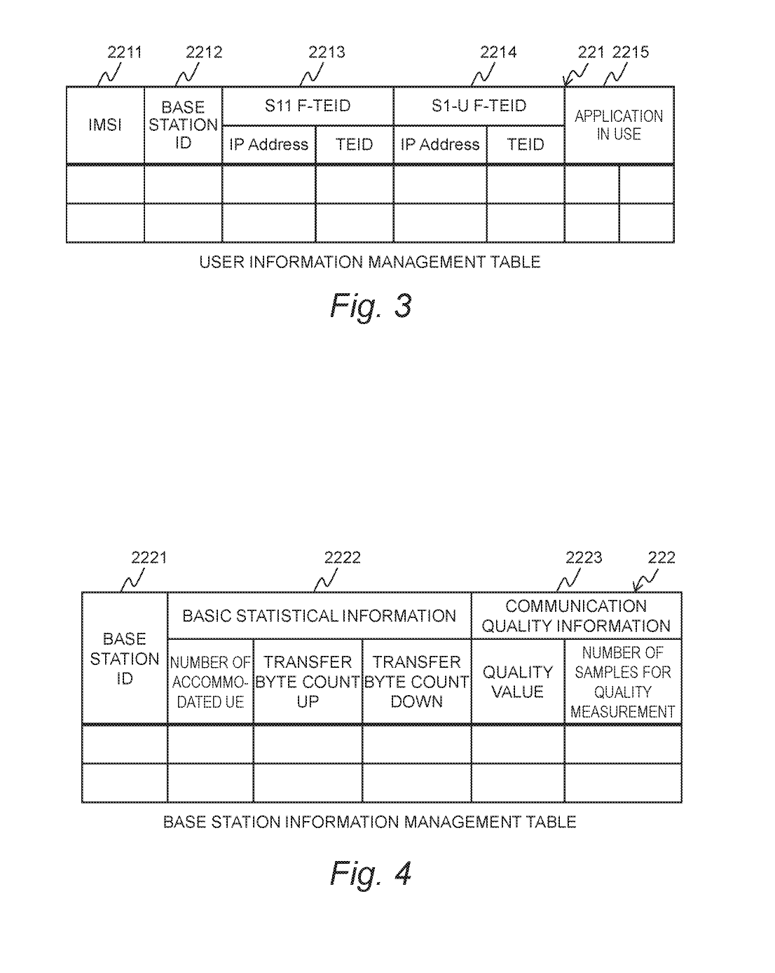

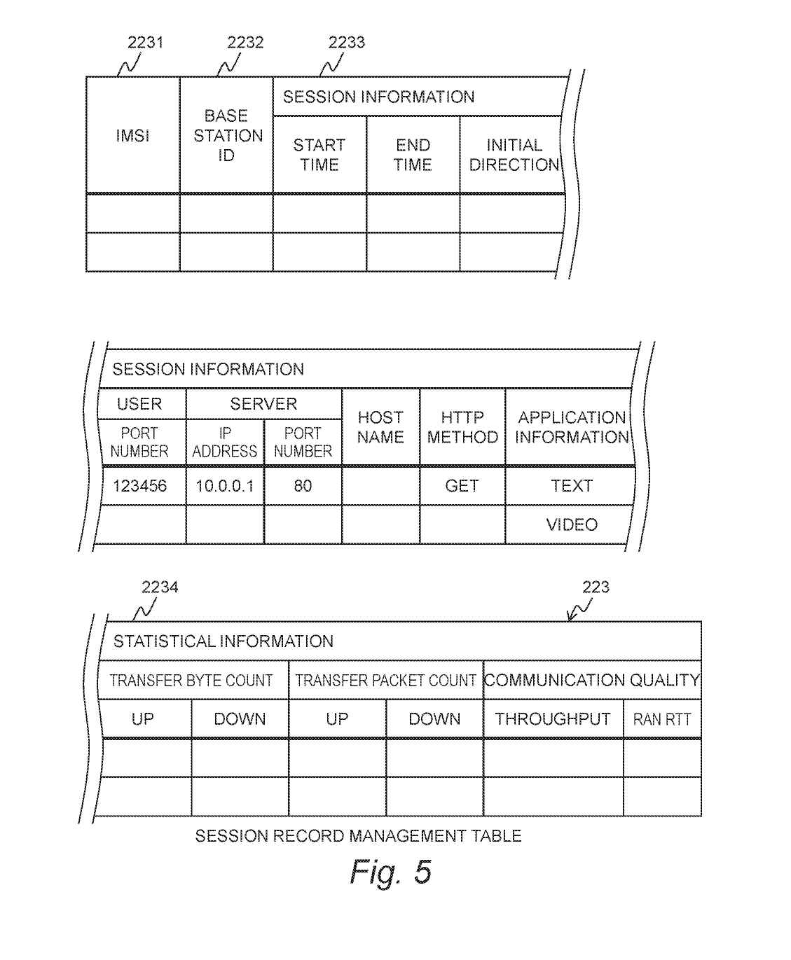

The functions of the DPI 141 are stored in an auxiliary storage unit 202 of a general computer in the form of programs (software), and a CPU 204 loads the programs, which were read out from the auxiliary storage unit 202, in a memory 203 and executes the programs. The DPI 141 obtains the traffic transferred at the respective reference points via a network I/F 205. The DPI 141 communicates with the traffic management server 143 via the network I/F 205. The memory 203 of the DPI 141 stores therein a user presence information updating process program 211 and a base station information updating process program 212. The memory 203 of the DPI 141 further stores a user information management table 221 (see FIG. 3), a base station information management table 222 (see FIG. 4), and a session record management table 223 (see FIG. 5).

The DPI 141 sends, to the traffic management server 143, the generated user information management table 221 and base station information control table 222.

The program to be executed by the CPU 204 is provided to the DPI 141 in a removable medium (such as CD-ROM or flash memory) or through a network, and is stored in the auxiliary storage unit 202, which is a non-transitory storage medium. Thus, it is preferable that the DPI 141 has an interface that reads out data from the removable medium.

The DPI 141 is a computer system which may be made up of one computer physically or a plurality of computers physically or theoretically, and the above-mentioned programs may operate on separated threads on the same computer, or operate on a virtual computer built on a plurality of physical computer resources.

The features of the DPI 141 of the first embodiment can be summarized as follows. The DPI 141 obtains the signaling traffic input to and output from the S-GW 131 through the S11 interface as well as the user traffic transferred through the S1-U interface, sorts out the user traffic for each UE 101 and each session, updates the user information management table 221 and the base station information management table 222, and sends out the updated user information and base station information to the traffic management server 143.

FIG. 3 is a diagram illustrating an example of a configuration of the user information management table 221 of the first embodiment.

The user information management table 221 contains the information of each UE 101 connected to the wireless communication system. Specifically, the user information management table 221 includes IMSI 2211 provided for identifying each UE 101, identification information (ECGI, for example) 2212 for identifying a eNodeB 111 containing the UE 101, identification information (F-TEID) 2213 for identifying each S11 interface, identification information (F-TEID) 2214 for identifying each S1-U interface, and identification information 2215 of application programs used by the UE 101. F-TEIDs 2213 and 2214 include TEID, which an identifier for IP address and tunnel.

FIG. 4 is a diagram illustrating an example of a configuration of the base station information management table 222 of the first embodiment.

The base station information management table 222 contains the information of each eNodeB 111 in the wireless communication system. Specifically, the base station information management table 222 contains the information of respective eNodeBs 111 constituting the wireless communication system. Specifically, the base station information management table 222 includes identification information (ECGI, for example) 2221 provided for identifying each eNodeB 111, statistical information 2222 of the eNodeB 111, and communication quality information 2223 of the eNodeB 111.

The statistical information 2222 includes the number of UE 101 connected to the eNodeB 111, and the up and down data transfer amounts (byte counts, for example) transferred by the eNodeB 111 during a predetermined period of time. The communication quality information 2223 includes the quality value and the number of samples used in measuring the quality value. The quality value includes throughput (bps) and RTT. If the quality value is throughput, the number of samples is the number of sessions used to measure the throughput. Examples of RTT as the quality value include a ratio of sessions not exceeding a predetermined value (50 msec, for example), and statistical values such as an average value.

FIG. 5 is a diagram illustrating an example of a configuration of the session record management table 223 of the first embodiment.

The session record management table 223 contains the information regarding ongoing sessions. Specifically, the session record management table 223 includes identification information (IMSI, for example) 2231 for a UE 101, identification information 2232 for a eNodeB 111 containing the UE 101, session information 2233 for a session involving the UE 101, and the statistical information 2234 of the session.

The session information 2233 includes start and end times of the session, and the initial direction of the communication. The initial direction of the communication is either from the UE or from the server, and is determined based on the originator of the packets initially received in the session. The session information 2233 also includes information for identifying a session such as the port number of the UE, IP address of the server, the port number of the server, the host name and the HTTP method. The session information 903 also includes identification information for an application that uses this session. The statistical information 2234 includes up and down transfer byte counts, up and down transfer packet counts, and communication quality (such as throughput and RAN RTT).

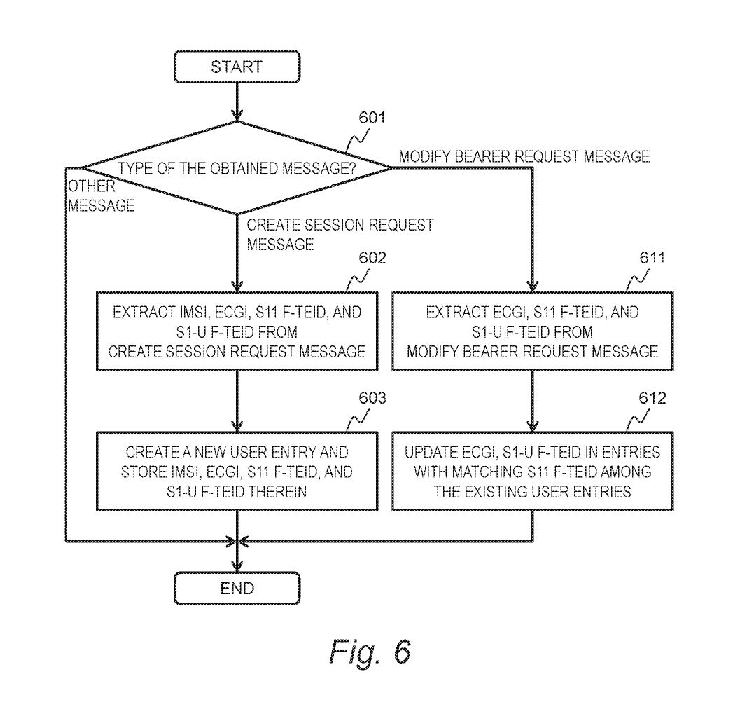

FIG. 6 is a flowchart of the user presence information update process of the first embodiment. In a case of receiving a message from the S11 interface, the user presence information updating process program 211 performs the user presence information updating process, thereby updating the user information management table 221.

First, the CPU 204 of the DPI 141 determines the type of the message received through the S11 interface. If the received message is a Create Session Request Message, this means that a new UE 101 is connected to the eNodeB 111, and the process moves to Step 602. If the received message is a Modify Bearer Request Message, this means that a UE 101 is switched to another eNodeB 111 (hand-over, for example), and the process moves to Step 611. If the received message is neither of the two, the user presence information updating process is ended.

In Step 602, the CPU 204 extracts IMSI, ECGI, S11 F-TEID, and S1-U F-TEID from the received Create Session Request Message. Then in Step 603, the CPU 204 creates a new user entry in the user information management table 221, and IMSI, ECGI, S11 F-TEID, and S1-U F-TEID are stored in the user information management table 221.

On the other hand, in Step 611, the CPU 204 extracts ECGI, S11, and F-TEID from the received Modify Bearer Request Message. In Step 612, among the existing user entries in the user information management table 221, the CPU 204 updates ECGI of each entry with a matching S11 F-TEID.

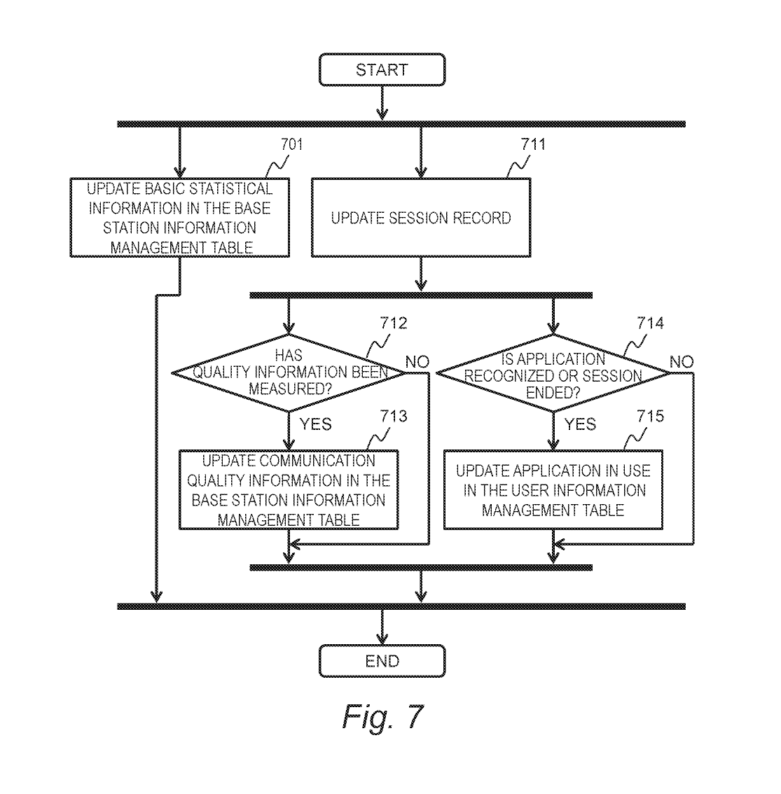

FIG. 7 is a flowchart of the base station information updating process of the first embodiment. When receiving a message through the S1-U interface, the base station information updating process program 212 performs the base station information updating process, and updates the base station information management table 222 and the session record management table 223.

First, the CPU 204 of the DPI 141 updates the basic statistical information 2222 of the base station information management table 222 based on the message received through the S1-U interface (701). For example, the DPI 141 extracts TEID from the user traffic of the S1-U interface, and when detecting a connection of a new UE 101, increases the number of connected UE. When detecting a disconnection of a UE 101, the DPI 141 reduces the number of connected UE. DPI 141 counts the data amount transferred by the S-GW 131 through the S1-U interface.

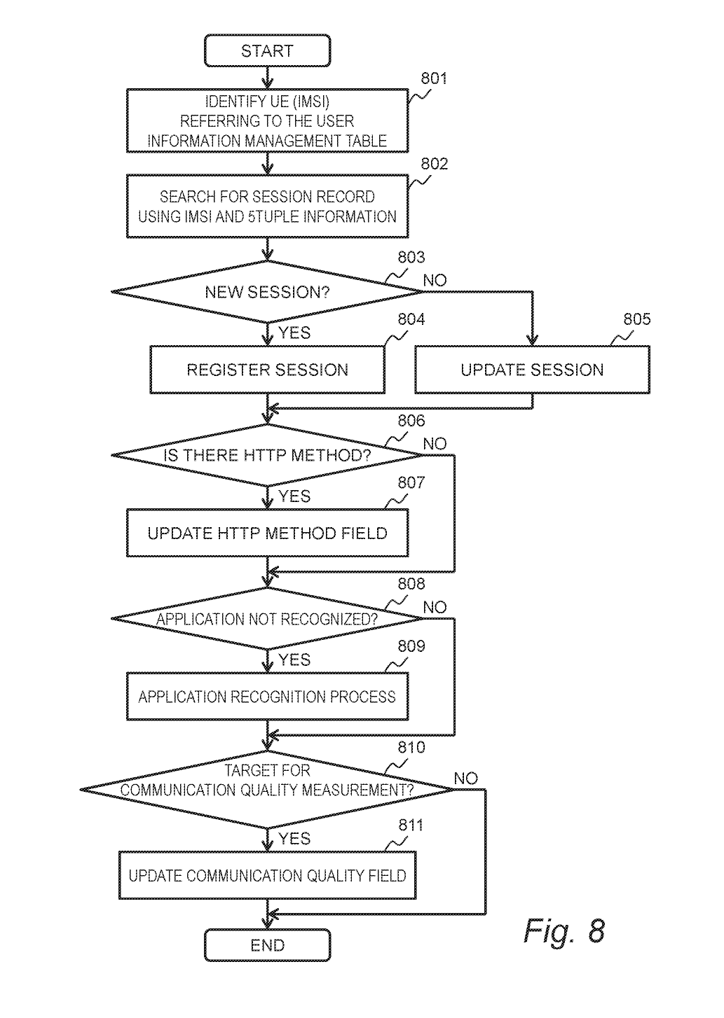

The CPU 204 updates the session record management table 223 based on the message received through the S1-U interface (711). The process to update the session record management table 223 will be explained below in detail with reference to FIG. 8.

The CPU 204 then determines whether the measurement of the quality information has been completed or not (712), and if the measurement of the quality information has been completed, the DPI 141 updates the communication quality information 2223 of the base station information management table 222 (713).

Next, the CPU 204 determines whether the application program used by the UE 101 has been recognized or not, or whether the session has been ended or not (714), and if the application program has been recognized or the session has been ended, the DPI 141 updates the application in use 2214 of the user information management table 221.

FIG. 8 is a flowchart of the session record updating process of the first embodiment.

First, the CPU 204 of the DPI 141 refers to the user information management table 221, and identifies the UE 101 (IMIS, for example) based on the TEID extracted from the user traffic of the S1-U interface (801).

Then the CPU 204 searches for a session record using the identified IMSI and 5 tulple (sender IP address, recipient IP address, sender port number, recipient IP port number, and protocol type) extracted from the user traffic of the S1-U interface (802).

If the user traffic obtained through the S1-U interface is for a new session (YES in 803), the CPU 204 registers the new session in the session record management table 223 (804). On the other hand, if the user traffic obtained through the S1-U interface is for the existing session (NO in 803), the CPU 204 updates the session record management table 223 using the information of the user traffic (805).

Thereafter, the CPU 204 determines whether the user traffic obtained through S1-U interface includes the information of HTTP method or not (806). If the user traffic includes the HTTP method information, the CPU 204 updates the HTTP method field of the session record management table 223 (807).

Next, the CPU 204 determines whether the application program for the user traffic obtained through the S1-U interface has been recognized or not (808). If the application program has not been recognized, the CPU 204 performs an application recognition process for recognizing the application program for the user traffic (809).

The CPU 204 then determines whether the communication quality of the user traffic obtained through the S1-U interface is to be measured or not (810). If the communication quality of the user traffic is to be measured, the CPU 204 measures the communication quality, and updates the communication quality field of the session record management table 223 (811).

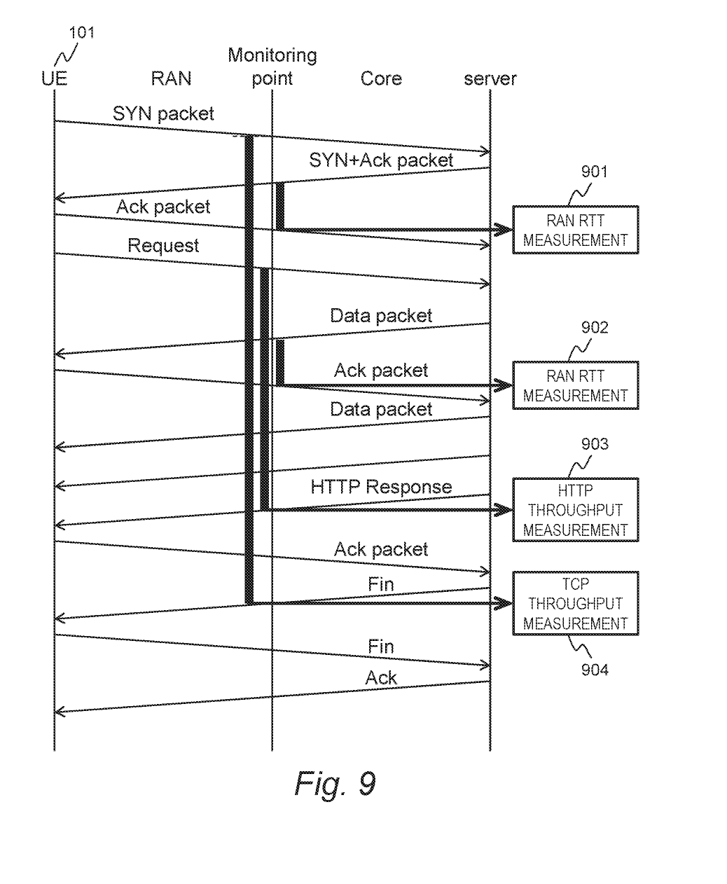

FIG. 9 is a diagram illustrating a communication quality measurement timings of the first embodiment.

The communication quality measured in the present invention is measured typically with the following four measurement methods after obtaining the packet transferred between the UE 101 and the server on the PDN 134 at a packet obtaining point on the network:

1. RAN RTT measurement using SYN packet (901)

Time difference between the SYN+Ack packet and corresponding Ack packet;

2. RAN RTT measurement using data packet (902)

Time difference between the Data packet and corresponding Ack packet;

3. HTTP session throughput measurement (903)

Time difference between the Request packet and corresponding HTTP response packet; and

4. TCP session throughput measurement (904)

Time difference between the SYN packet and corresponding Fin packet.

Although not shown in the figure, it is also possible to measure the throughput every time a predetermined data transfer amount is reached (100 kb, for example).

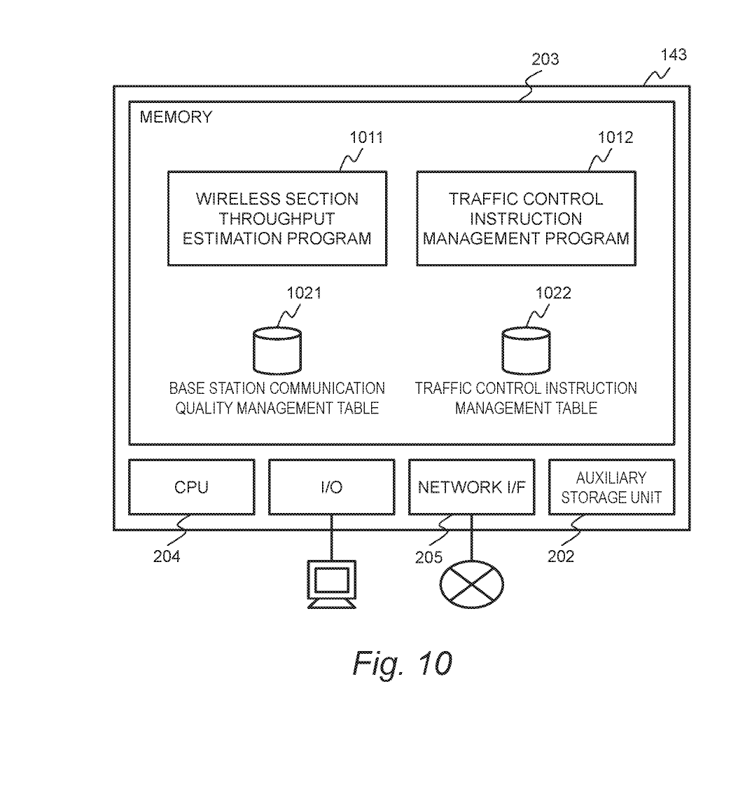

FIG. 10 is a diagram illustrating a configuration of the traffic management server 143 of the first embodiment.

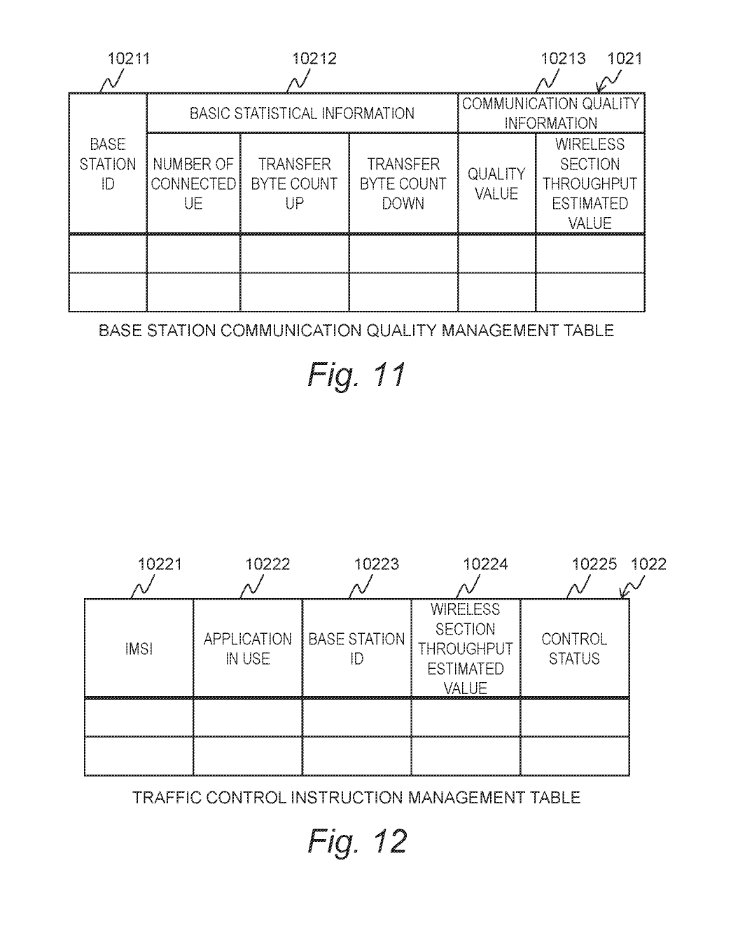

The functions of the traffic management server 143 are stored in an auxiliary storage unit 202 of a general computer in the form of programs (software), and the CPU 204 loads the programs, which are read out from the auxiliary storage unit 202, in a memory and executes the programs. The traffic management server 143 communicates with the DPI 141 through the network I/F 205. The memory 203 of the traffic management server 143 stores therein a wireless section throughput estimation program 1011 and a traffic control instruction management program 1012. The memory 203 of the traffic management server 143 also stores therein a base station communication quality management table 1021 (see FIG. 11) and a traffic control instruction management table 1022 (see FIG. 12).

The programs to be executed by the CPU 204 are provided to the traffic management server 143 in a removable medium (such as CD-ROM or flash memory) or through network, and are stored in the auxiliary storage unit 202, which is a non-transitory storage medium. Thus, it is preferable that the traffic management server 143 has an interface that reads out data from the removable medium.

The traffic management server 143 is a computer system made up of one computer physically or a plurality of computers physically or theoretically, and the above-mentioned programs may operate on separated threads on the same computer, or operate on a virtual computer built on a plurality of physical computer resources.

The features of the traffic management server 143 of the first embodiment can be summarized as follows. The traffic management server 143 obtains the user information and base station information from the DPI 141, and sends a traffic control instruction to the P-GW 133 or the video compressor 145 based on the obtained user information and base station information.

FIG. 11 is a diagram illustrating an example of a configuration of the base station communication quality management table 1021 of the first embodiment.

The base station communication quality management table 1021 is a table for recording the estimation results of the communication quality of each UE 101. Specifically, the base station communication quality management table 1021 includes identification information (ECGI, for example) 10211 provided for identifying each eNodeB 111, statistical information 10212 obtained from the DPI 141, and communication quality information 10213 of the eNodeB 111.

The statistical information 10212 is the same as the statistical information 2222 of the base station information management table 222, and includes the number of UE 101 connected to the eNodeB 111, and the up and down data transfer amounts (byte counts, for example) transferred by the eNodeB 111 during a predetermined period of time. The communication quality information 10213 includes quality values and estimated values of the wireless section throughput. The quality values are the same as the quality values of the communication quality information 2223 of the base station information management table 222 (HTTP session throughput, TCP session throughput, and RAN RTT). The estimated values of the wireless section throughput are calculated by the CPU 204 of the traffic management server 143 in the method described below.

First, the wireless section throughput can be estimated based on the HTTP session throughput using Formula (1).

Wireless section throughput=http_thorughput×coefficient (1)

Coefficient=exp(β0+β1×http_throughput+β2×transfer byte count+β3× the number of connected UE)

By using the HTTP session throughput for the communication quality information, even when the sub-layer is not available, the wireless section throughput can be estimated using the application layer session.

Alternatively, the wireless section throughput can be estimated based on the TCP session throughput using Formula (2).

Wireless section throughput=tcp_thorughput×coefficient (2)

Coefficient=exp(β0+β1×tcp_throughput+β2×transfer byte count+β3× the number of connected UE)

By using the TCP session throughput for the communication quality information, the wireless section throughput can be estimated using the communication information of a wide variety of protocols of the upper layers. The wireless section throughput can also be estimated based on RTT using Formula (3).

Wireless section throughput=exp(β0+β1×RAN_RTT) (3)

By using RAN RTT of the wireless section for the communication quality information, the wireless section throughput can be estimated with ease.

Parameters [symbol] 0 to [symbol] 3 in Formulae (1) to (3) are predetermined parameters, and may be constants defined by the user, or may be determined based on the statistical information of the communication quality as described in a second embodiment below. The parameters [symbol] 0 to [symbol] 3 may be the common values within the wireless communication system, or may differ depending on the type of eNodeB 111 (the number of sectors, for example), or differ among respective eNodeBs 111.

The estimated value of the wireless section throughput may be calculated by one of the above-described methods, which was selected by the user or selected for having fewest errors, or may be a value obtained by performing a statistical process on the estimated values calculated by a plurality of methods.

FIG. 12 is a diagram illustrating an example of a configuration of the traffic control instruction management table 1022 of the first embodiment.

The traffic control instruction management table 1022 has stored therein the content of traffic control instructions given by the traffic management server 143 to the P-GW 133 or the video compressor 145. Specifically, the traffic control instruction management table 1022 includes identification information (IMSI, for example) 10221 for identifying each UE 101, identification information 10222 for the application program used by the UE 101, identification information (ECGI, for example) 10223 for identifying each eNodeB 111, the wireless section throughput estimated value 10224 between the UE 101 and the eNodeB 111, and the traffic control status 10225 of the UE 101.

The identification information 10222 of the application program indicates the application program identified based on the message received by the DPI 141 through the S1-U interface and recorded in the user information management table 221. The throughput estimated value 10224 is a value calculated by the traffic management server 143 and recorded in the base station communication quality management table 1021.

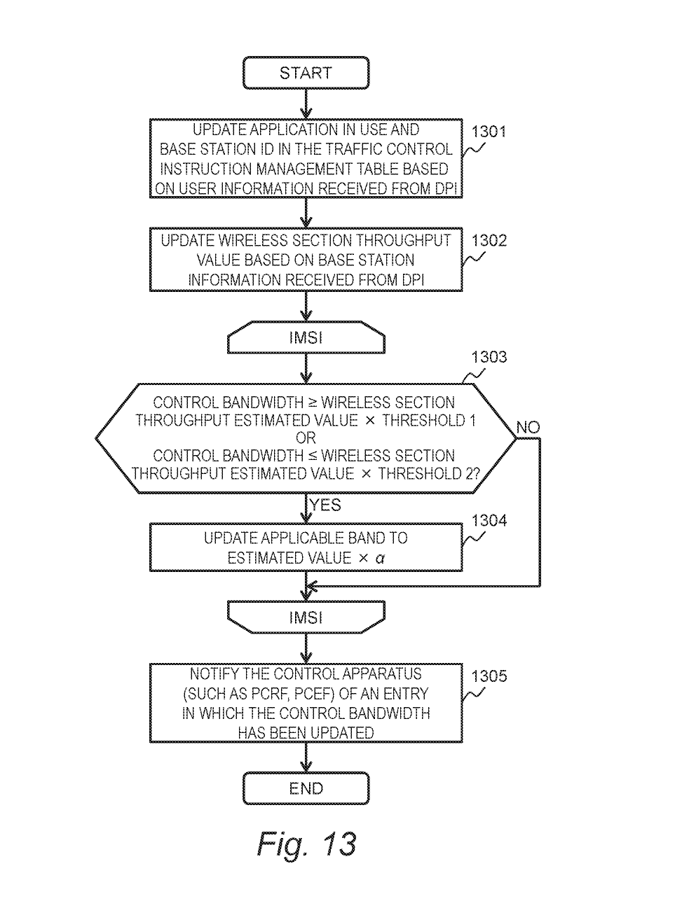

FIG. 13 is a flowchart of the traffic control instruction management process of the first embodiment.

When the traffic control instruction management table 1022 is to be updated (specifically, in a case where the user information and/or base station information is received from the DPI 131), the traffic control instruction management program 1012 performs the traffic control instruction management process, and updates the traffic control instruction management table 1022. The traffic control instruction management program 1012 may also perform the traffic control instruction management process at a predetermined timing (at a predetermined interval, for example).

First, the CPU 204 of the traffic management server 143 updates the application program identification information 10222 and base station ID 10223 of the traffic control instruction management table 1022 using the user information received by the DPI 131 (1301). Then, using the base station information received by the DPI 141, the CPU 204 updates the wireless section throughput estimated value 10224 of the traffic control instruction management table 1022 (1302).

Thereafter, for each UE 101, Steps 1303 and 1304 are repeated. In the loop, the CPU 204 determines whether the control bandwidth needs to be updated or not based on the following conditions (1303).

Control bandwidth≧Wireless section throughput estimated value×threshold 1 Condition 1:

Control bandwidth≦Wireless section throughput estimated value×threshold 2 Condition 2:

The thresholds 1 and 2 in Conditions 1 and 2 are values for defining the range to update the control bandwidth, and may be freely set by the user.

In a case where one of Conditions 1 and 2 is met, the CPU 204 updates the applicable control bandwidth to the throughput estimated value× a in Step 1304. “a” is a coefficient indicating a margin of the control bandwidth from the throughput estimated value.

After the throughput estimated value updating process is completed for all of the UEs 101, the CPU 204 sends entries with updated control bandwidth to the control apparatus (such as PCRF or PCEF in the P-GW 133, or the video compressor 145) in Step 1305.

As described above, according to the first embodiment, it is possible to estimate the communication quality (throughput) of the wireless section provided by the eNodeB 111 in real-time, using a message sent and received by the S-GW 131 through the S11 interface and the packets sent and received through the S1-U interface.

In the conventional configuration, the wireless section communication quality of the eNodeB 111 was measured with a long cycle (every 15 minutes, for example), and was not appropriate for a bandwidth control at a shorter cycle (several seconds to several tens of seconds). On the other hand, in the first embodiment, the wireless section communication quality can be estimated for each eNodeB 111 without delay regardless of the difference in performance due to the type of eNodeB 111 (such as the number of sectors or bandwidth), and it is possible to detect congestion in each eNodeB 111 without delay. It is also possible to perform the bandwidth control for each terminal based on the wireless communication quality. Furthermore, the video compressor 145 can control the amount of video data sent to the UE 101 by changing the compression method or resolution of a video depending on the wireless communication quality.

In particular, in the first embodiment, it is possible to estimate the wireless section throughput of each user for each eNodeB 111 in such a manner that the throughput is not affected by the difference in performance due to the type of eNodeB 111 (such as the number of sectors or bandwidth).

Because the traffic can be controlled using a single reference indicator throughout the wireless communication system, it is possible to prevent the control from being inconsistent within the same system.

### Second Embodiment

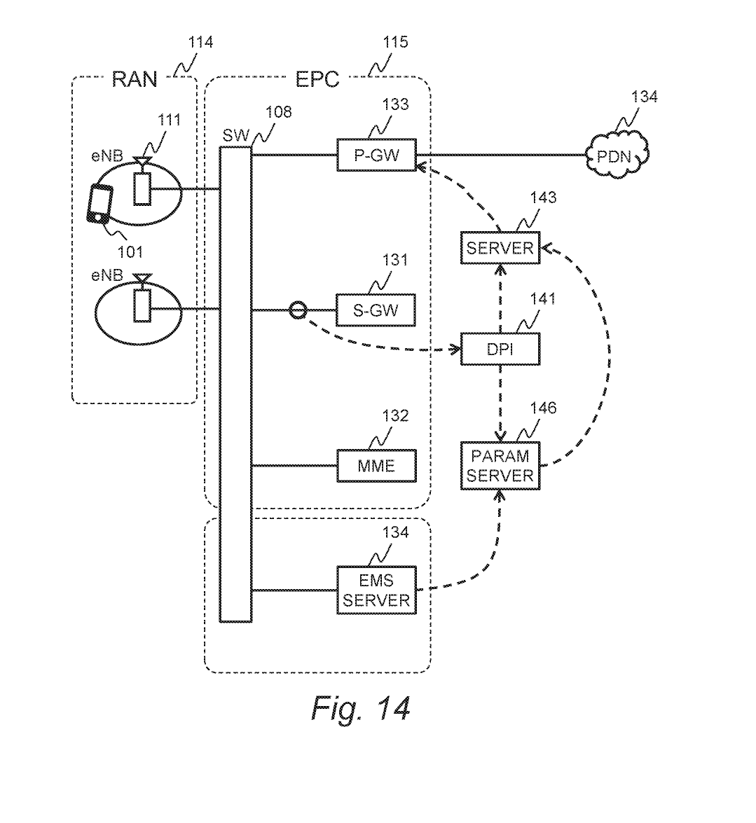

A second embodiment of the present invention will be explained with reference to FIGS. 14 to 19. The second embodiment differs from the first embodiment in that the wireless communication system has a parameter server 146. In the second embodiment, differences from the first embodiment only will be explained. The same configurations and processes as those of the first embodiment will be given the same reference characters, and the descriptions thereof are omitted. In the first embodiment, the parameters [symbol] 0 to [symbol] 3, which are used to estimate the wireless section throughput, were constants set by the user, but in the second embodiment, the parameters are defined based on the statistical information of the past communication quality. In the throughput estimating method of the first embodiment, the parameters [symbol] 0 to [symbol] 3 were freely set by the user, which possibly reduces the accuracy in estimating the wireless section throughput, but in the second embodiment, the throughput estimation accuracy is improved.

FIG. 14 is a diagram illustrating a configuration of a wireless communication system of the second embodiment.

The wireless communication system of the second embodiment includes a eNodeB 111 as a base station device, an S-GW 131 and a P-GW 133 as gateway apparatuses, an MME 132 as a communication control device, an EMS server 135, DPI 141 as a packet analyzer, a traffic management server 143, and a parameter server 146. The eNodeB 111 is connected to a UE 101, which is a user terminal. Although not shown in FIG. 14, the wireless communication system of the second embodiment may have a video compressor 145.

The MME 132 is a device to control the mobility of the UE 101, and sends and receives signaling of control plane. The EMS server 135 is an element management system that manages the respective nodes involved in the wireless communication system. Specifically, the EMS server 135 collects the statistical information of each node (such as the amount of data transferred by the eNodeB 111 and wireless section throughput measured by the eNodeB 111).

The parameter server 146 calculates parameters [symbol] 0 to [symbol] 3, which are used to estimate the wireless section throughput, using the PM statistics (statistical information measured by the eNodeB 111) obtained from the EMS server 135 and DPI statistics (statistical values of the message sent and received by the S11 interface and the message sent and received by the S1-U interface), and outputs the parameters to the traffic management server 143. The traffic management server 143 calculates estimated values of the wireless section throughput, using the parameters [symbol] 0 to [symbol] 3 calculated by the parameter server 146.

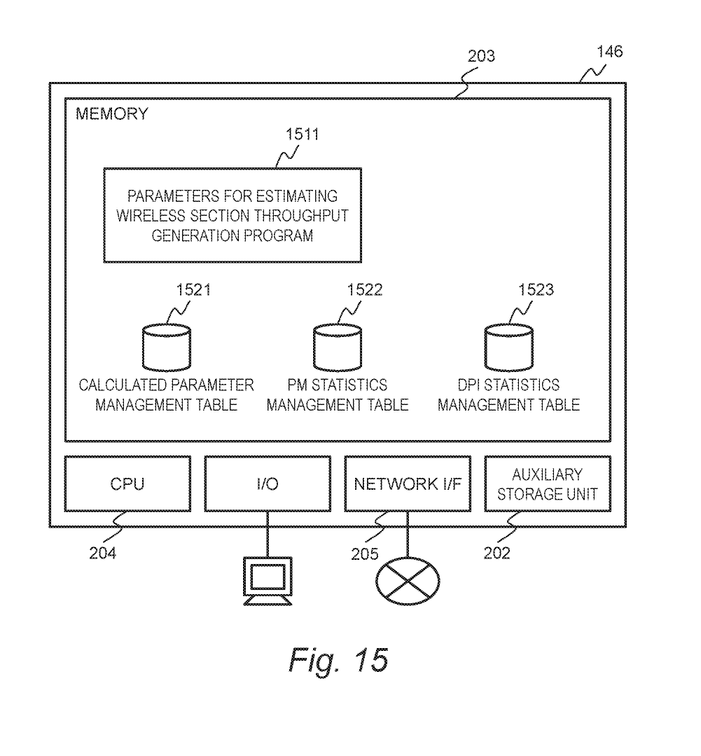

FIG. 15 is a diagram illustrating a configuration of the parameter server 146 of the second embodiment.

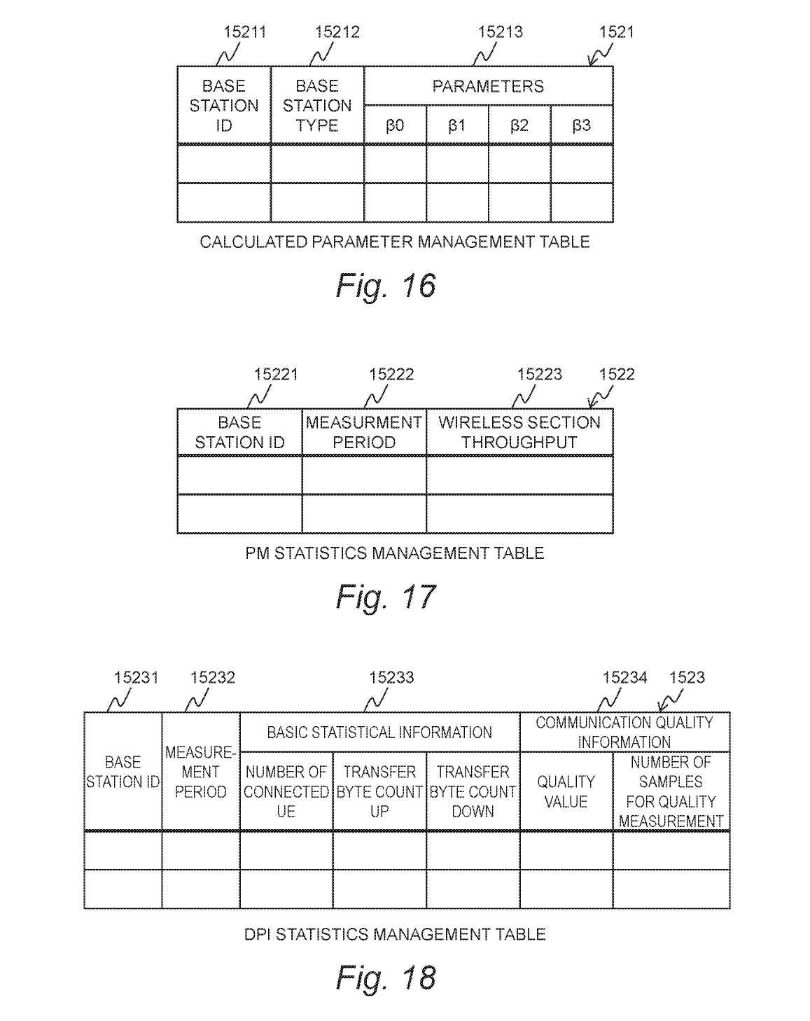

The functions of the parameter server 146 are stored in an auxiliary storage unit 202 of a general computer in the form of a program (software), and the CPU 204 opens the program, which is read out from the auxiliary storage unit 202, in a memory and executes the program. The parameter server 146 communicates with the EMS server 135, DPI 141, and traffic management server 143 through the network I/F 205. The memory 203 of the parameter server 146 stores therein parameters for estimating wireless section throughput generation program 1511. The memory 203 of the parameter server 146 has stored therein a calculated parameter management table 1521 (see FIG. 16), a PM statistics management table 1522 (see FIG. 17), and a DPI statistics management table 1523 (see FIG. 18).

The program to be executed by the CPU 204 is provided to the parameter server 146 in a removable medium (such as CD-ROM or flash memory) or through network, and is stored in the auxiliary storage unit 202, which is a non-transitory storage medium. Thus, it is preferable that the parameter server 146 have an interface that reads out data from the removable medium.

The parameter server 146 is a computer system made up of one computer physically or a plurality of computers physically or theoretically, and the above-mentioned program may operate on separated threads on the same computer, or operate on a virtual computer built on a plurality of physical computer resources.

The features of the parameter server 146 of the second embodiment can be summarized as follows. That is, the parameter server 146 calculates parameters [symbol] 0 to [symbol] 3, which are used to estimate the wireless section throughput, using the measured value of the communication quality information of the eNodeB 111 obtained from the EMS server 135 (such as the wireless section throughput) and the communication quality information (such as the number of connected UE and the amount of data transferred) obtained from the DPI 141, and outputs those parameters to the traffic management server 143.

FIG. 16 is a diagram illustrating a configuration example of the calculated parameter management table 1521 of the second embodiment.

The calculated parameter management table 1521 is a table for recording parameters [symbol] 0 to [symbol] 3 calculated by the parameter server 146. Specifically, the calculated parameter management table 1521 includes identification information (ECGI, for example) 15211 provided for identifying each eNodeB 111, the type of the eNodeB 15212, and the calculated parameters 15213.

The eNodeB type 15212 is the number of sectors implemented in the eNodeB 11, the bandwidth, and the like. The parameter 15213 includes [symbol] 0, [symbol] 1, [symbol] 2, and [symbol] 3.

The calculated parameter management table 1521 shown in the figure includes both the eNodeB identification information 15211 and the eNodeB type 15212, but the calculated parameter management table 1521 may alternatively include either one of the eNodeB identification information 15211 and the eNodeB type 15212. In a case where the table includes the eNodeB identification information 15211 only, the parameters 15213 are calculated for each eNodeB. In a case where the table includes the eNodeB type 15212 only, the parameters 15213 are calculated for each eNodeB type.

FIG. 17 is a diagram illustrating an example of a configuration of the PM statistics management table 1522 of the second embodiment.

The PM statistics management table 1522 is a table for recording the information of each eNodeB 111 obtained from the EMS server 135. Specifically, the PM statistics management table 1522 includes identification information (ECGI, for example) 15221 provided for identifying each eNodeB 111, the measurement period 15222 of the wireless section throughput, and the wireless section throughput 15223.

The throughput 15223 is the wireless section throughput actually measured in the eNodeB 111. The measurement period 15222 is a length of time during which the wireless section throughput 15223 was measured in the eNodeB 111.

FIG. 18 is a diagram illustrating an example of a configuration of the DPI statistics management table 1523 of the second embodiment.

The DPI statistics management table 1523 is a table for recording the information of each eNodeB 111 obtained from the DPI 141. Specifically, the DPI statistics management table 1523 includes identification information (ECGI, for example) 15231 provided for identifying each eNodeB 111, the measurement period 15232 of the basic statistical information and communication quality information, statistical information 15233 of the eNodeB 111, and communication quality information 15234 of the eNodeB 111.

In a case where the parameter server 146 obtains information of a eNodeB 111 from the DPI 141 at a regular interval, the regular interval is recorded in the measurement period 15232. The statistical information 15233 includes the number of UE 101 connected to the eNodeB 111, and the up and down data transfer amounts (byte counts, for example) transferred by the eNodeB 111 during a predetermined period of time. The communication quality information 15234 includes the quality value and the number of samples used in measuring the quality value. The quality value includes throughput (bps) and RTT. If the quality value is throughput, the number of samples is the number of sessions used to measure the throughput. Examples of RTT as the quality value include a ratio of sessions not exceeding a predetermined value (50 msec, for example), and statistical values such as an average value.

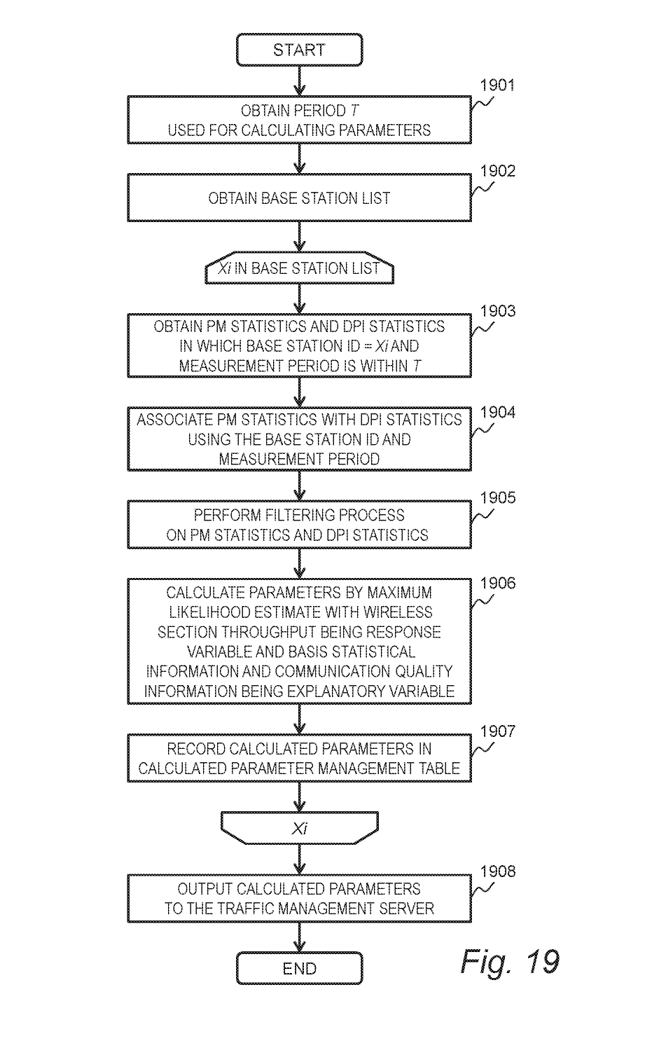

FIG. 19 is a flowchart of the process to generate parameters for estimating the wireless section throughput of the second embodiment.

The parameters for estimating the wireless section throughput generation program 1511 performs a process to generate parameters for estimating the wireless section throughput at a predetermined timing (such as at a regular interval or at a timing selected by the user), and updates the calculated parameter management table 1521. The parameters for estimating the wireless section throughput generation program 1511 may also perform the process to generate parameters for estimating the wireless section throughput when the PM statistics management table 1522 and/or the DPI statistics management table 1523 is updated.

First, the CPU 204 of the parameter server 146 obtains the period T used for calculating parameters (1901). The period T may be selected by the user or may be an interval at which the process to generate parameters for estimating the wireless section throughput is performed (predetermined interval).

Next, the CPU 204 obtains a list of base stations for which the parameters are to be calculated. The list of base stations can be obtained from the base station ID 15231 of the DPI statistics management table 1523, or from the server that controls eNodeBs 111 (such as the EMS server 135), for example.

Then, the CPU 204 selects one eNodeB 11 from the list of base stations, and repeats the following steps 1903 to 1907.

In Step 1903, the CPU 204 obtains PM statistics and DPI statistics that have Xi for the base station ID and that are included in the measurement period T from the PM statistics management table 1522 and the DPI statistics management table 1523, respectively. Then using the base station ID and measurement period, PM statistics and DPI statistics are associated with each other (1904). Thereafter, the PM statistics and DPI statistics are subjected to a filtering process (1905). In the filtering process, statistics with the sample number being smaller than a predetermined threshold and statistics with the connected user number being smaller than a predetermined threshold are eliminated, so that the variations in the parameters due to abnormal values can be suppressed.

Then with the maximum likelihood estimate with the wireless section throughput being the response variable and the basic statistical information and communication quality information being the explanatory variables, the parameters are calculated (1906), and the calculated parameters are recorded in the calculated parameter management table 1521 (1907).

After the parameter calculation is completed for all eNodeBs 111, the CPU 204 outputs the calculated parameters to the traffic management server 143 (1908).

Alternatively, common parameters [symbol] 0 to [symbol] 3 may be calculated for the entire wireless communication system instead of performing the same process repeatedly for the respective eNodeBs 111. It is also possible to obtain different parameters [symbol] 0 to [symbol] 3 for the respective types of eNodeB 111 by repeating the process for the respective types of eNodeB 111 (such as the sector number).

As described above, in the second embodiment, the parameter server 146 calculates parameters [symbol] 0 to [symbol] 3, which are to be used for estimating the wireless section throughput, using the PM statistics obtained from the EMS server 135 and the DPI statistics obtained from the DPI 141. Because it is possible to take into consideration the difference due to the installation environment of the eNodeB 111 (whether UEs 101 are concentrated at the cell edge or at the cell center, and the like) in calculating the estimated value of the throughput, it is possible to calculate the throughput more accurately. As a result, more appropriate bandwidth control is achieved.

### Third Embodiment

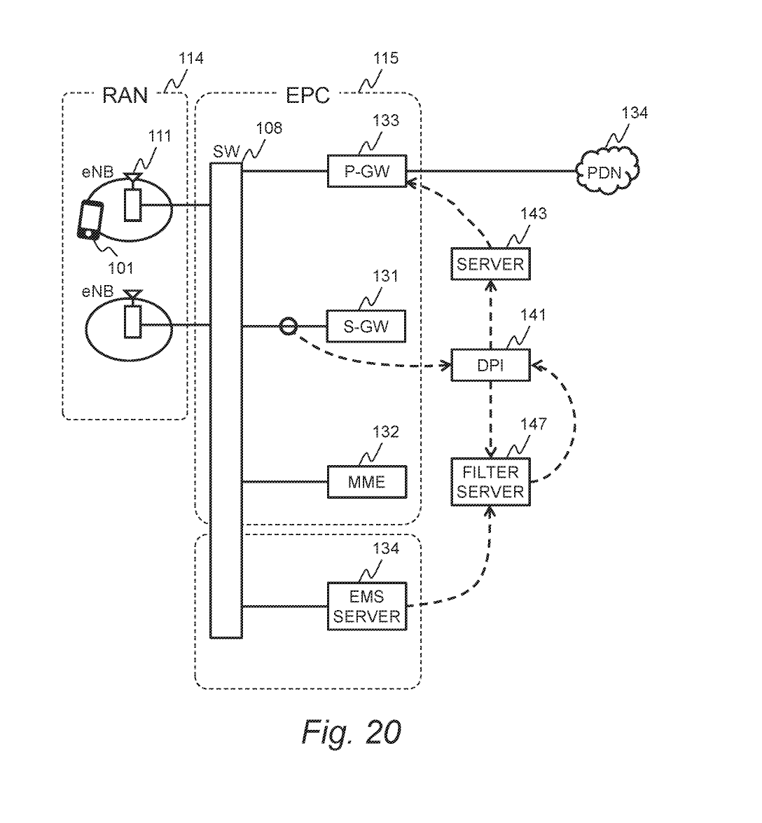

A third embodiment of the present invention will be explained with reference to FIGS. 20 to 23. The third embodiment differs from the first embodiment in that the wireless communication system has a filter server 147. In the third embodiment, differences from the respective embodiments above only will be explained. The same configurations and processes as those of the first and second embodiments will be given the same reference characters, and the descriptions thereof are omitted. In the third embodiment, a filter that extracts the communication quality having a greater correlation with the wireless section throughput is generated, and the wireless section throughput is estimated using the communication quality selected by the generated filter. This makes it possible to improve the accuracy in estimating the communication quality.

FIG. 20 is a diagram illustrating a configuration of a wireless communication system of the third embodiment.

The wireless communication system of the third embodiment includes a eNodeB 111 as a base station device, an S-GW 131 and a P-GW 133 as gateway apparatuses, an MME 132 as a communication management device, an EMS server 135, a DPI 141 as a packet analyzer, a traffic management server 143, and a filter server 147. The eNodeB 111 is connected to a UE 101, which is a user terminal. Although not shown in FIG. 20, the wireless communication system of the third embodiment may also include a video compressor 145.

The filter server 147 generates a filter for selecting communication quality information, using the PM statistics from the EMS server 135 and the session log information from the S-GW 131, and outputs the filter to the DPI 141. The DPI 141 selects session information using the filter obtained from the filter server 147, and measures the communication quality.

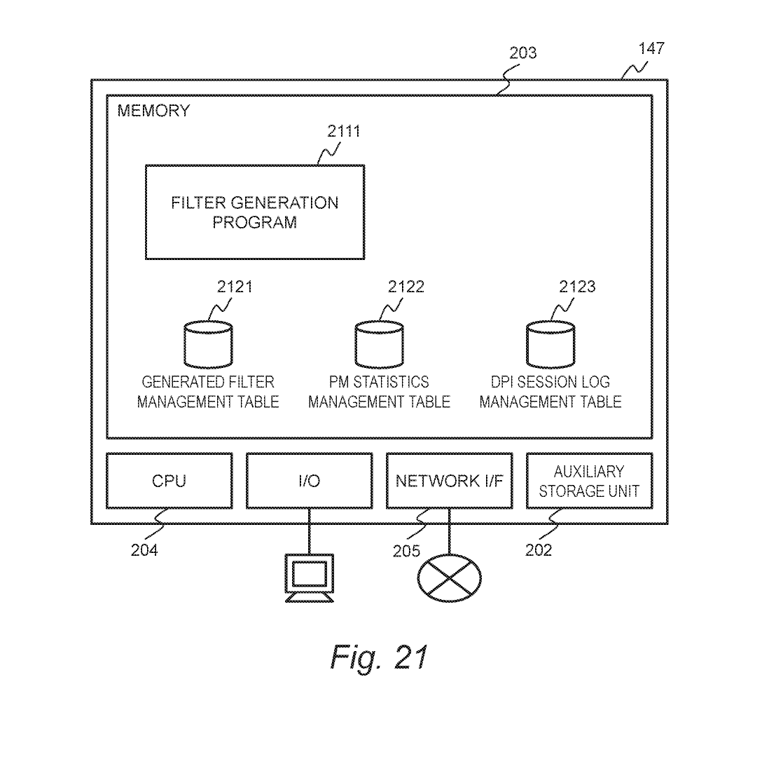

FIG. 21 is a diagram illustrating a configuration of the filter server 147 of the third embodiment.

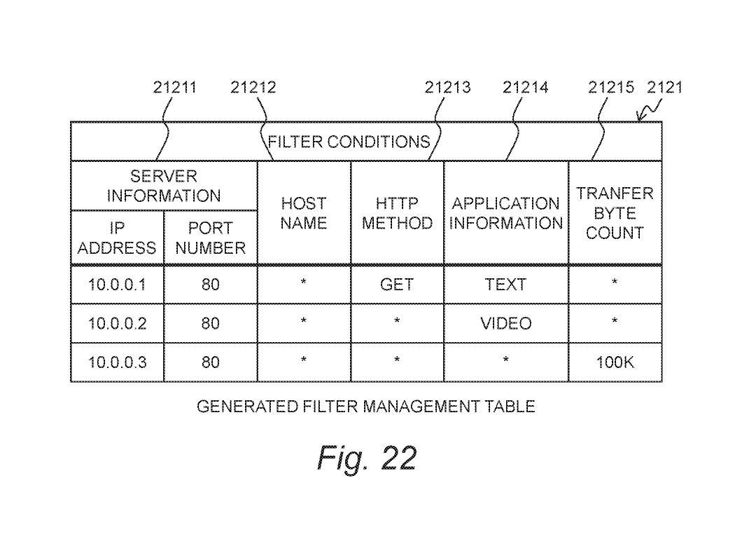

The functions of the filter server 147 are stored in an auxiliary storage unit 202 of a general computer in the form of a program (software), and the CPU 204 loads the program, which is read out from the auxiliary storage unit 202, in a memory and executes the program. The filter server 147 communicates with the EMS server 135 and the DPI 141 via the network I/F 205. The memory 203 of the filter server 147 stores therein a filter generation program 2111. The memory 203 of the filter server 147 has stored therein a generated filter management table 2121 (see FIG. 22), a PM statistics management table 2122, and a DPI session log management table 2123.

The PM statistics management table 2122 is the same as the PM statistics management table 1522 of the parameter server 146 of the second embodiment. The DPI session log management table 2123 is the same as the session record management table 223 of the DPI 141.

The program to be executed by the CPU 204 is provided to the filter server 147 in a removable medium (such as CD-ROM or flash memory) or through network, and is stored in the auxiliary storage unit 202, which is a non-transitory storage medium. Thus, it is preferable that the filter server 147 have an interface that reads out data from the removable medium.

The filter server 147 is a computer system made up of one computer physically or a plurality of computers physically or theoretically, and the above-mentioned program may operate on separated threads on the same computer, or operate on a virtual computer built on a plurality of physical computer resources.

The features of the parameter server 147 of the third embodiment can be summarized as follows. That is, the filter server 147 generates a filter for selecting the communication quality information, using the measured value of the communication quality information of the eNodeB 111 obtained from the EMS server 135 (wireless section throughput, for example), and the session log information obtained from the DPI 141.

FIG. 22 is a diagram illustrating an example of a configuration of the generated filter management table 2121 of the third embodiment.

The generated filter management table 2121 is a table for recording filters generated by the filter server 147. Specifically, the generated filter management table 2121 includes server information 21211 for identifying each server that terminates a session, the host name 21212 for the server, the HTTP method 21213 for the session, identification information 21214 for identifying the application program for the session, and the data amount 21215 transferred in the session.

The server information 21211 includes IP address and port number of a server at which the session is terminated. Under the data amount 21215, the range or lower limit value of the amount of data transferred in each session is recorded.

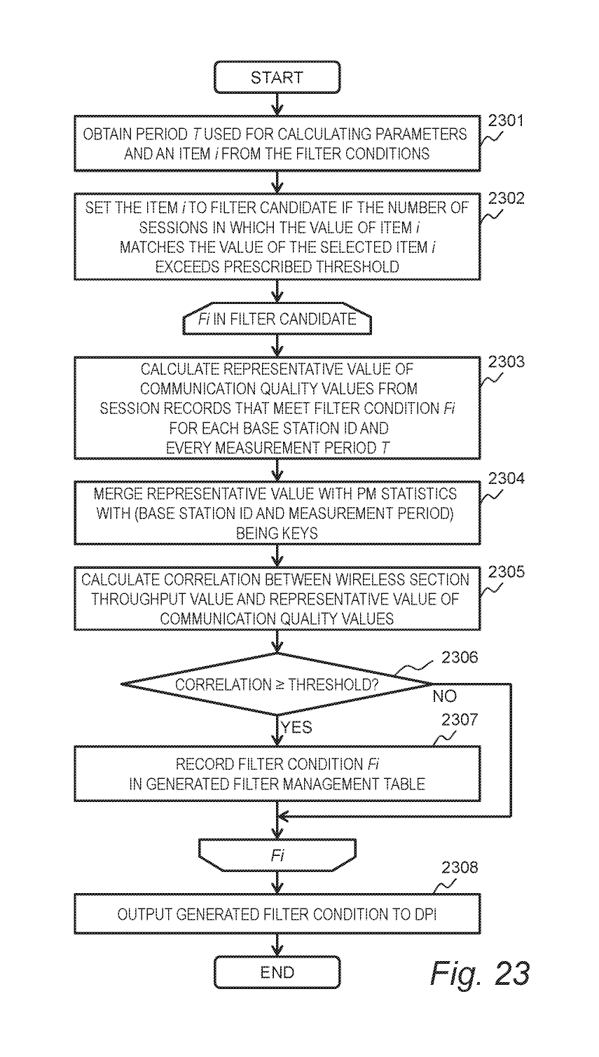

FIG. 23 is a flowchart of the filter generation process of the third embodiment.

First, the CPU 204 of the filter server 147 obtains a period T required for parameter calculation, and obtains at least one item i included in the filtering conditions (2301). The period T may be selected by the user or may be an interval at which the process to generate parameters for estimating the wireless section throughput is performed (predetermined interval). The items in the filtering conditions may be set by the user.

The CPU 204 counts the number of sessions having the value of the items i matching the filtering condition, and when the number of session is at least a predetermined number, the value of the item i is set to the filter candidate. In this way, a group of filter candidates is generated (2302). By excluding the filtering process having a small number of sessions, the filtering conditions that result in effective statistical values can be selected. Also, by reducing the number of filters to be generated, the load on DPI 141 due to the filtering process can be mitigated.

Thereafter, one filter candidate Fi is selected from the group of filter candidates, and Steps 2303 to 2307 are repeated for each filter candidate Fi. In Step 2303, a representative value of the communication quality values is calculated from the session records that meet the conditions of the filter candidate Fi for each combination of the base station ID and measurement period T (2303). The representative value is a value obtained by statistically processing the communication quality values during the measurement period, and the average value or median value can be used, for example.

Thereafter, using the base station ID and measurement period, the PM statistics (measured value of the wireless section throughput) and the representative value of the communication quality value are associated with each other (2304).

Next, the correlation coefficient between the measured value of the wireless section throughput and the representative value of the communication quality value is calculated (2305), and the correlation coefficient is then compared with a predetermined threshold (2306). If the correlation coefficient is at least the predetermined threshold, the conditions of the filter candidate Fi are correlated to the throughput value, and the filter candidate Fi is considered an effective filter. Thus, the filter candidate Fi is recorded in the generated filter management table 2121 (2307).

After the correlation with the measured value of the wireless section throughput is determined for all filter candidates Fi, the generated filtering conditions are output to the DPI 141 (2308).

The DPI 141 adds, to the base station information management table 222, the communication quality measured using a session fulfilling the filtering conditions received in Step 713 of the base station information updating process (FIG. 7). The base station management table 222 may be a single common table for all of the filtering conditions, or a plurality of tables may be provided for the respective filtering conditions. Because the respective filtering conditions have different levels of effects on the traffic management, if a different table is provided for each filtering condition, a wide range of traffic management can be achieved.

As described above, in the third embodiment, a filter that extracts the communication quality having a greater correlation with the measured value of the wireless section throughput is generated, and the wireless section throughput is estimated using the communication quality selected by the generated filter. This makes it possible to improve the accuracy in estimating the wireless throughput.

By using the TCP session throughput for the communication quality information, the wireless section throughput can be estimated using the communication information of a wide variety of protocols. Thus, it is desirable to calculate the wireless section throughput estimated value by selecting a session having a greater correlation with the wireless section throughput using a filter. For example, a session with a large transfer data amount such as file download is suitably used for estimating the wireless section throughput, but if TCP session throughput is used, the information of a session with a small transfer data amount would also be used. With the third embodiment, the communication quality information used to estimate the wireless section throughput can be selected by a filter. Also, sessions by an application that controls throughput in the application layer can be excluded in estimating the wireless section throughput.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings illustrate control lines and information lines as considered necessary for explanation but do not illustrate all control lines or information lines in the products. It can be considered that almost of all components are actually interconnected.

What is claimed is:

1. A communication management apparatus that manages traffic of a wireless communication system that includes a wireless base station communicating with a terminal, and a gateway apparatus coupled to the wireless base station, the communication management apparatus comprising:
a processor that executes a program; and
a storage unit accessed by the processor,
wherein the communication management apparatus calculates an estimated value of wireless section throughput between the wireless base station and the terminal using communication quality information obtained from data sent and received by the gateway apparatus.

2. The communication management apparatus according to claim 1, wherein the communication quality information is a round trip time of data sent and received by the gateway apparatus.

3. The communication management apparatus according to claim 1, wherein the communication quality information is throughput of a TCP session sent and received by the gateway apparatus, and
wherein the communication management apparatus calculates an estimated value of wireless section throughput between the wireless base station and the terminal using the communication quality information, an amount of data transferred by the gateway apparatus, and the number of terminals connected to the wireless base station.

4. The communication management apparatus according to claim 1, wherein the communication quality information is throughput of an HTTP session sent and received by the gateway apparatus, and
wherein the communication management apparatus calculates an estimated value of wireless section throughput between the wireless base station and the terminal using the communication quality information, an amount of data transferred by the gateway apparatus, and the number of terminals connected to the wireless base station.

5. A communication system that exchanges user data with a terminal, comprising:
a communication management apparatus configured to manage traffic; and
an analyzer configured to analyze the traffic,
wherein the analyzer obtains data sent and received by a gateway apparatus coupled to a wireless base station that communicates with the terminal, and
wherein the communication management apparatus calculates an estimated value of wireless section throughput between the wireless base station and the terminal using communication quality information obtained from the data obtained by the analyzer.

6. The communication system according to claim 5, wherein the communication quality information is a round trip time of data sent and received by the gateway apparatus.

7. The communication system according to claim 5, wherein the communication quality information is throughput of a TCP session sent and received by the gateway apparatus, and
wherein the communication management apparatus calculates an estimated value of wireless section throughput between the wireless base station and the terminal using the communication quality information, an amount of data transferred by the gateway apparatus, and the number of terminals connected to the wireless base station.

8. The communication system according to claim 5, wherein the communication quality information is throughput of an HTTP session sent and received by the gateway apparatus, and
wherein the communication management apparatus calculates an estimated value of wireless section throughput between the wireless base station and the terminal using the communication quality information, an amount of data transferred by the gateway apparatus, and the number of terminals connected to the wireless base station.

9. The communication system according to claim 5, further comprising a parameter calculator that calculates a parameter used for calculating the estimated value of the wireless section throughput,
wherein the parameter calculator calculates the parameter using an actual value of the wireless section throughput measured by the wireless base station, an amount of data transferred by the gateway apparatus, and the number of terminals connected to the wireless base station.

10. The communication system according to claim 5, further comprising a filter generator that generates a filter used for selecting communication quality information to be used in calculating the estimated value of the wireless section throughput,
wherein the filter generator generates a filter using an actual value of the wireless section throughput measured by the wireless base station and communication quality information obtained by the gateway apparatus.

11. A non-transitory machine-readable storage medium, containing at least one sequence of instructions for managing traffic in a communication system that includes a wireless base station communicating with a terminal, and a gateway apparatus coupled to the wireless base station,
a communication management apparatus including a processor configured to execute the program and a storage unit configured to store the program,
the instructions that, when executed, causes the communication management apparatus to:
obtain communication quality information of data sent and received by the gateway apparatus; and
calculate an estimated value of wireless section throughput between the wireless base station and the terminal, using the obtained communication quality information.
